(19) United States
(12) Patent Application Publication
(10) Pub. No.: US 2023/0247483 A1
(43) Pub. Date: Aug. 3, 2023

(54) METHOD AND APPARATUS FOR RULE-BASED MISSION CRITICAL COMMUNICATION

(71) Applicant: SAMSUNG ELECTRONICS CO., LTD., Suwon-si (KR)

(72) Inventors: Kiran Gajula, Bangalore (IN); Siva Prasad Gundur, Bangalore (IN); Arunprasath Ramamoorthy, Bangalore (IN); Kiran Gurudev Kapale, Bangalore (IN)

(73) Assignee: SAMSUNG ELECTRONICS CO., LTD., Suwon-si (KR)

(21) Appl. No.: 18/105,058

(22) Filed: Feb. 2, 2023

Related U.S. Application Data
(63) Continuation of application No. PCT/KR23/01473, filed on Feb. 1, 2023.

(30) Foreign Application Priority Data
Feb. 2, 2022 (IN) 202241005702
Jan. 19, 2023 (IN) 202241005702

(51) Int. Cl. H04W 28/08; H04W 28/02

(52) U.S. Cl. CPC H04W 28/0925; H04W 28/0268

(57) ABSTRACT

A method for rule-based mission critical (MCX) communication by an MCS server is provided. The method includes: receiving, from an MCX client, an MCX service request which includes rule-set information for the MCX service request; determining at least one MCX participant required for the MCX service request based on the rule-set information for the MCX service request; and initiating a wireless communication between the determined MCX participant and the MCX client based on the rule-set information for the MCX service request.

### CROSS-REFERENCE TO RELATED APPLICATIONS

This application is a continuation of International Application No. PCT/KR2023/001473 designating the United States, filed on Feb. 1, 2023, in the Korean Intellectual Property Receiving Office and claiming priority to Indian Provisional Patent Application No. 202241005702 filed on Feb. 2, 2022, in the Indian Patent Office, and Indian Complete Patent Application No. 202241005702 filed on Jan. 19, 2023, in the Indian Patent Office, the disclosures of which are incorporated by reference herein in their entireties.

### FIELD OF INVENTION

The disclosure relates to wireless communication, and more particularly, to a method and a system for rule-based Mission Critical (MCX) communication.

### BACKGROUND

Mission critical (MCX) services such as a mission-critical push-to-talk (MCPTT) service, a Mission-Critical Video (MCVideo) service, Mission-Critical Data (MCData) service, and any other known MCX service enable a user/User Equipment (UE) to initiate communication with one or more users/UEs. The current services are based on Pre-Arranged Group, Private or Ad-hoc Group Communication. In group communication, any user/UE may send voice/video/data in a group session, so that everyone involved in the group session receives the data. A group may be a pre-defined/pre-arranged group or may be an ad-hoc group with a set of participants.

The development of MCX system in Third-Generation Partnership Project (3GPP) is highly driven by customers themselves (e.g., public safety operators/agencies such as Government of South Korea, United Kingdom, United States, Japan, Germany, Canada and various other countries around world). The development of the MCX systems is a high priority task for the public safety operators/agencies. At present, the use of the MCX systems is extended for Railway critical communications called as Long-Term Evolution (LTE) for Railways (LTE-R) project, Coast Guards and all Government Utility agencies such as electricity and gas departments. The MCX system is a gateway for future 3GPP Future Railway Mobile Communication Systems (FRMCS) and Maritime Critical communications.

In MCX services of the related art, the communication does not provide any flexibility to an MCX User to select rescue team participants based on a type of emergency situation and location. In case of emergency situation, an MCX Client/First Responder seeks assistance immediately to handle the emergency situation. With services of the related art, the first responder makes a pre-arranged group call or an Ad-hoc group call for assistance. During the pre-arranged group call, many first responders may not be available nearby the location of emergency situation or may not be approachable or busy with other assignments, leading to delay or issue in handling the emergency situation better. During the Ad-hoc group call, the first responder has to select the other first responders manually with specific criteria, thereby delaying initiating the communication. Further, selecting the first responders is also difficult because of lack of information like location of all the first responders, availability of the first responders, expertness of the first responders, etc. Therefore, there is a need for a faster and effective communication system.

Thus, it is desired to address the above mentioned disadvantages or other shortcomings.

### OBJECT OF INVENTION

Provided is a method and a system for rule-based Mission Critical (MCX) communication. The method includes invoking MCX service based on rule-set information provided by an MCX client i.e., initiating a communication with a group of other MCX clients based on the rule-set/situation information. The rule-set information includes target location information, target location range, emergency type/requirement, an expert group of personnel and the like. For an example, in case of emergency situation, the MCX client requires assistance from nearby located MCX clients for faster response. In that case, an Authorized MCX Client can initiate MCX communication in a faster and effective manner.

Further, the MCX client can specify the emergency type and/or the location range (e.g. in meters) from the emergency situation location.

Further still, an MCX server can identify the other MCX Clients/First Responders (FRs) within the specified location range, form a temporary group, and initiate communication between the MCX client and the identified MCX Clients/FRs efficiently.

Further still, the MCX client can specify expert/seniority level of FRs for expert suggestions/advisory to handle the emergency situation. The MCX server can identify the FRs based on the experience of the FRs in the field, and form the temporary group and initiate communication in a user friendly manner.

### SUMMARY

According to an aspect of the disclosure, a method for rule-based mission critical (MCX) communication by a MCS server, includes: receiving, from an MCX client, an MCX service request which includes rule-set information for the MCX service request; determining at least one MCX participant required for the MCX service request based on the rule-set information for the MCX service request; and initiating wireless communication between the determined at least one MCX participant and the MCX client based on the rule-set information for the MCX service request.

The rule-set information may include at least one of a location information, an emergency type, a minimum number of MCX clients/first responders (FRs), an availability of the MCX clients/FRs, and an expert level of the MCX clients/FRs.

The determining the at least one MCX participant required for the MCX service request may include: receiving, from the MCX client, a fetch participants request which includes at least one rule-set information for the fetch participants request; verifying the fetch participants request received from the MCX client based on the rule-set information for the fetch participants request; and determining the at least one MCX participant satisfying the rule-set information for the fetch participants request.

The initiating the wireless communication between the determined MCX participant and the MCX client may include: sending a communication request invite to the determined at least one MCX participant; receiving an invite accept response from the determined at least one MCX participant; verifying the received invite accept response based on the received rule-set information; and sending the verified invite accept response to the MCX client to establish the wireless communication between the determined at least one MCX participant and the MCX client.

The communication request invite may be sent to the determined MCX participant based on identifying a mission critical event.

According to an aspect of the disclosure, a method for rule-based mission critical (MCX) communication by an MCX server, includes: receiving, from an MCX client, an ad hoc group call request which includes rule-set information for the ad hoc group call request; identifying a mission critical event based on the ad hoc group call request received from the MCX client; determining, upon identifying the mission critical event, a group of MCX participants required for the ad hoc group call request; and initiating an ad hoc group call between the determined group of MCX participants and the MCX client based on the rule-set information for the ad hoc group call request.

The rule-set information may include at least one of a location information, an emergency type, a minimum number of MCX clients/first responders (FRs), an availability of the MCX clients/FRs, and an expert level of the MCX clients/FRs.

The initiating the ad hoc group call between the determined group of MCX participants and the MCX client may include: sending an ad hoc group call invite to the determined group of MCX participants; receiving the invite accept response from the determined group of MCX participants; verifying the received invite accept response based on the received rule-set information; and sending the verified invite accept response to the MCX client to establish the ad hoc group call between the determined group of MCX participants and the MCX client.

According to an aspect of the disclosure, a mission critical (MCX) server for rule-based MCX communication, includes: a memory; a communicator; and at least one processor coupled to the memory and the communicator, the at least one processor being configured to: receive an MCX service request which includes at least one rule-set information for the MCX service request; determine at least one MCX participant required for the MCX service request based on the rule-set information for the MCX service request; and initiate wireless communication between the determined at least one MCX participant and the MCX client based on the rule-set information for the MCX service request.

The rule-set information may include at least one of a location information, an emergency type, a minimum number of MCX clients/first responders (FRs), an availability of the MCX clients/FRs, and an expert level of the MCX clients/FRs.

The at least one processor may be configured to determine the at least one MCX participant required for the MCX service request by: receiving, from the MCX client, a fetch participants request which includes rule-set information for the fetch participants request; verifying the fetch participants request received from the MCX client based on the rule-set information for the fetch participants request; and determining the at least one MCX participant satisfying the rule-set information for the fetch participants request.

The at least one processor may be configured to initiate the wireless communication between the determined MCX participant and the MCX client by: sending a communication request invite to the determined at least one MCX participant; receiving an invite accept response from the determined at least one MCX participant; verifying the received invite accept response based on the received rule-set information; and sending the verified invite accept response to the MCX client to establish the wireless communication between the determined at least one MCX participant and the MCX client.

The communication request invite may be sent to the determined MCX participant based on identifying a mission critical event.

According to an aspect of the disclosure, a mission critical (MCX) server for rule-based MCX communication, includes: a memory; a communicator; and at least one processor coupled to the memory and the communicator, the at least one processor being configured to: receive, from an MCX client, an ad hoc group call request which includes at least one rule-set information for the ad hoc group call request; identify the mission critical event based on the ad hoc group call request received from the MCX client; determine a group of MCX participants required for the ad hoc group call request upon identifying the mission critical event; and initiate an ad hoc group call between the determined group of MCX participants and the MCX client based on the rule-set information for the ad hoc group call request.

The rule-set information may include at least one of a location information, an emergency type, a minimum number of MCX clients/first responders (FRs), an availability of the MCX clients/FRs, and an expert level of the MCX clients/FRs.

The at least one processor may be configured to initiate the ad hoc group call between the determined group of MCX participants and the MCX client by: sending an ad hoc group call invite to the determined group of MCX participants; receiving the invite accept response from the determined group of MCX participants; verifying the received invite accept response based on the received rule-set information; and sending the verified invite accept response to the MCX client to establish the ad hoc group call between the determined group of MCX participants and the MCX client.

These and other aspects of the embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the embodiments herein without departing from the embodiments thereof, and the embodiments herein include all such modifications.

### BRIEF DESCRIPTION OF FIGURES

The above and other aspects, features, and advantages of certain embodiments of the present disclosure will be more apparent from the following description taken in conjunction with the accompanying drawings, in which:

FIG. 1 is a block diagram of a Mission Critical (MCX) server for rule-based MCX communication, according to one or more embodiments;

FIG. 2 is a flow chart illustrating a method for rule-based MCX communication, according to one or more embodiments;

FIG. 3 is an example illustrating an operation-by-operation procedure for identifying a Group of First Responders (FRs), according to one or more embodiments;

FIG. 4 is an example illustrating an operation-by-operation procedure for fetching participants list using rule-set information, according to one or more embodiments; and

FIG. 5 is an example illustrating an operation-by-operation procedure for sending communication request invite with the rule-set information to other MCX clients/FRs, according to one or more embodiments.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The embodiments herein disclose a method for rule-based Mission Critical (MCX) communication. The method includes, for example, receiving an MCX service request from an MCX client by an MCX server. The MCX service request may include rule-set information for the MCX service request. The method may include determining an MCX participant required for the MCX service request based on the rule-set information. The method may also include initiating a wireless communication between the determined MCX participant and the MCX client by the MCX server based on the rule-set information.

Accordingly, the embodiments herein disclose a system for rule-based MCX communication. The system may include a memory, a processor coupled to the memory, a communicator coupled to the memory and the processor, and a communication controller coupled to the memory, the processor and the communicator. The communication controller may be configured to receive the MCX service request from the MCX client by the MCX server. The MCX service request may include the rule-set information for the MCX service request. The communication controller may be configured to determine the MCX participant required for the MCX service request based on the rule-set information, and initiate the wireless communication between the determined MCX participant and the MCX client by the MCX server based on the rule-set information.

Methods and systems of the related art create a dynamic group at a controller by obtaining location information of user devices. The related art methods include forming the dynamic location-based group ensuring required responders. The related art methods include receiving a request for a new location-based group call relative to a defined location at the controller from an initiating device. At this stage, the controller is burdened with multiple time consuming tasks. For example, thee controller determines a plurality of required responder types for responding to the location and forms a group including subscriber units meeting one of a plurality of required responder types and a set of location-based group formation rules. The controller determines if the subscriber units in the formed group meet the required responder types. If not, the controller modifies the location-based group formation rules and re-forms the group including the subscriber units meeting one of the plurality of required responder types and the modified location-based group formation rules. The controller then causes audio or data transmitted by the initiating device to be provided to the subscriber units in the re-formed group. However, the related art methods do not describe how an initiating client can initiate communication based on a set of rules defined by the client.

Related art methods and systems use mobile applications to alert certified first trainees to respond to a scene of an emergency. That is, the related art methods relate to responding to the emergencies. More particularly, the related art methods relate to providing alerts to proximate, trained personnel in the scene of the emergency, such as a medical emergency. Properly receiving an emergency response from the trained personnel is a serious problem. In the related art methods, when seconds are critical to an emergency response, a responder and/or the trained personnel is at least several minutes away. Thereby, leading to delay or issue in adequately handling the emergency situation.

Unlike the related art methods and systems, the embodiments of the present disclosure specify an emergency type and/or an emergency situation location range from an emergency situation location upon receiving the MCX service request from the MCX client. The MCX service request includes the rule-set information. The rule-set information includes, but not limited to, the location range, the emergency type, a minimum number of MCX clients/first responders (FRs), an availability of the MCX clients/FRs, and an expert level of the MCX clients/FRs. The embodiments of the present disclosure also identify the number of MCX clients/participants required for handling the emergency situation based on the rule-set information. Furthermore, the embodiments of the present disclosure create a temporary group including the identified MCX clients/participants and initiate wireless communication/ad hoc group call between the identified MCX clients/participants and the MCX initiating client based on the rule-set information in an efficient manner.

Furthermore, the proposed method may specify the minimum number of FRs required for handling the emergency situation. The MCX server may identify the FRs based on their locality and availability, and form the temporary group including the identified FRs and initiate communication between the identified FRs and the client. The proposed method may also specify expert/seniority level of the FRs for expert suggestions/advisory to handle the emergency situation. The MCX server may identify the FRs based on experience of the FRs in the field, and form the temporary group including the identified FRs and initiate communication between the identified FRs and the client rapidly.

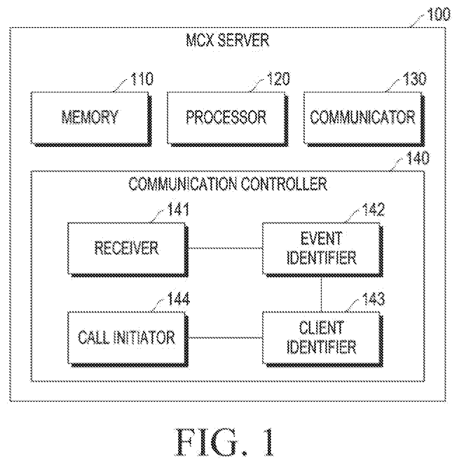

Referring now to the drawings and more particularly to FIGS. 1 through 5, where similar reference characters denote corresponding features consistently throughout the figure, these are shown example embodiments.

FIG. 1 is a block diagram of an MCX server 100 included in a system for rule-based mission critical (MCX) communication, according to one or more embodiments. The MCX server 100 operates in combination with an MCX client device. An example for the MCX client device is a User Equipment (UE). The UE may be, but not limited, to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system.

In one or more embodiments, the MCX server 100 of the system may include a memory 110, a processor 120, a communicator 130, a communication controller 140 and a display 150.

The memory 110 may be configured to store the rule-set information. The rule-set information includes, but not limited to a location range, an emergency type, a minimum number of MCX clients/first responders (FRs), an availability of the MCX clients/FRs, and an expert level of the MCX clients/FRs. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. Furthermore, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 may be configured to store larger amounts of information. In certain examples, a non-transitory storage medium may store data that can, over time, change (e.g., in Random Access Memory (RAM) or cache).

The processor 120 may include one or a plurality of processors. The one or the plurality of processors 120 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 120 may include multiple cores and may be configured to execute the rule-set information stored in the memory 110. The processor 120 may control operations of other components of the MCX server. The operations of the MCX server 100 may be understood as substantially executed by the processor 120.

In one or more embodiments, the communicator 130 may include an electronic circuit specific to a standard that enables wired or wireless communication. The communicator 130 may be configured to communicate internally between internal hardware components such as, for example, the memory 110, the processor 120, the communication controller 140 and the display 150 of the MCX server 100 and with external devices via one or more networks.

In one or more embodiments, the communication controller 140 includes a receiver 141, an event identifier 142, a client identifier 143 and a call initiator 144.

In one or more embodiments, the receiver 141 is configured to receive an MCX service request from an MCX client during an emergency situation and/or a mission critical event. The emergency situation and/or the mission critical event may include, but is not limited, to an accident, fire, flood, and medical emergency. The MCX service request may include a rule-set information for the MCX service request. The rule-set information may include, but is not limited to, a location range, an emergency type, a minimum number of MCX clients/first responders (FRs), an availability of the MCX clients/FRs, an expert level of the MCX clients/FRs, and any other emergency related information known to one of ordinary skill in the art.

In one or more embodiments, the event identifier 142 may be configured to identify the emergency situation and/or the mission critical event based on the MCX service request received from the MCX client by the receiver 141. The event identifier 142 may be configured to identify the emergency situation and/or the mission critical event to send a communication request to the MCX server. The communication request may be sent by the MCX client to the MCX server. The communication request may be sent in response to an identification of an emergency and/or mission critical event.

In one or more embodiments, the client identifier 143 may be configured to determine the number of the MCX clients/participants required for the MCX service request or the number of the MCX clients/participants required for handling the mission critical event upon identifying the mission critical event.

In one or more embodiments, the call initiator 144 may be configured to create a temporary group after determining the number of the MCX clients/participants required for handling the mission critical event. The temporary group may include the determined number of MCX clients/participants required for handling the mission critical event based on the rule-set information. The call initiator 144 may be configured to initiate wireless communication and/or wireless group communication between the determined number of MCX clients/participants and the MCX client based on the rule-set information. An example of wireless group communication may include, but is not limited to, ad hoc group communication.

In one or more embodiments, the call initiator 144 may initiate the wireless communication and/or the wireless group communication between the determined group of MCX participants and the MCX client by sending a communication request invite to the determined group of MCX participants. Upon sending the communication request invite to the determined group of MCX participants, the call initiator 144 may receive an invite accept response from the determined group of MCX participants. The received invite accept response may be verified based on the rule-set information. The verified invite accept response may be sent to the MCX client to establish the wireless communication and/or the wireless group communication between the determined group of MCX participants and the MCX client.

The communication controller 140 may be implemented by processing circuitry such as logic gates, integrated circuits, microprocessors, microcontrollers, memory circuits, passive electronic components, active electronic components, optical components, hardwired circuits, or any other logic components known to one of ordinary skill in the art. In one or more examples, the communication controller 140 may be driven by firmware. The circuits may, for example, be embodied in one or more semiconductor chips, on substrate supports such as printed circuit boards, and the like. The communication controller 140 and the processor 120 may be integrally referred to as at least one processor. The operations of the communication controller 140 may be substantially executed by the processor 120.

The MCX client device may include a memory, a communicator and at least one processor. The description of the memory 110 and the communicator 130 may be applied to the memory and the communicator of the MCX client device in the same way. The operations of the MCX client device described herein may be understood as executed by the at least one processor of the MCX client device.

In one or more examples, at least one of the plurality of modules/components of the communication controller 140 may be implemented through an AI model. A function associated with the AI model may be performed through memory 110 and the processor 120. The one or a plurality of processors may control the processing of the input data in accordance with a predefined operating rule or the AI model stored in the non-volatile memory and the volatile memory. The predefined operating rule or artificial intelligence model may be provided through training or learning.

In one or more examples, being provided through learning includes, but is not limited to, applying a learning process to a plurality of learning data to determine a predefined operating rule or configuring an AI model to one or more desired characteristics. The learning may be performed in a device itself in which AI according to one or more embodiments is performed, and/or may be implemented through a separate server/system.

The AI model may include a plurality of neural network layers. Each layer may have a plurality of weight values and perform a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process may be a method for training a predetermined target device (e.g., a robot) using a plurality of learning data to cause, allow, or control the target device to make a determination or prediction. Examples of learning processes include, but are not limited to, supervised learning, unsupervised learning, semi-supervised learning, or reinforcement learning.

As understood by one of ordinary skill in the art, the hardware elements of the MCX server 100 are merely an example, and the configuration of the MCX server 100 may be modified to include any other suitable hardware component. IN one or more embodiments, the MCX server 100 may include less or more number of elements. Further, the labels or names of the elements are used only for illustrative purpose and does not limit the scope of the embodiments. One or more components can be combined together to perform same or substantially similar function.

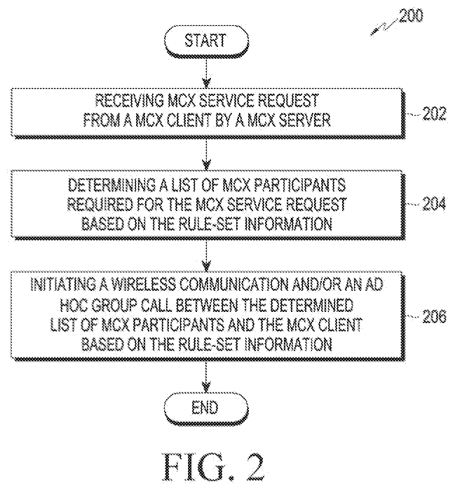

FIG. 2 is a flow chart 200 illustrating a method for rule-based MCX communication, according to one or more embodiments.

Referring to FIG. 2, at operation 202, the method may include the MCX server 100 receiving the MCX service request from the MCX client. The MCX service request may include the rule-set information for the MCX service request. For example, in the MCX server 100, as illustrated in the FIG. 1, the communication controller 140 may be configured to receive the MCX service request from the MCX client.

At operation 204, the method may include the MCX server 100 determining a list of MCX participants required for the MCX service request based on the rule-set information. For example, in the MCX server 100, as illustrated in FIG. 1, the communication controller 140 may be configured to determine the list of MCX participants required for the MCX service request based on the rule-set information.

At operation 206, the method may include the MCX server 100 initiating the wireless communication between the determined MCX participant and the MCX client based on the rule-set information. For example, in the MCX server 100, as illustrated in FIG. 1, the communication controller 140 may be configured to initiate the wireless communication between the determined MCX participant and the MCX client based on the rule-set information.

The various actions, acts, blocks, operations, or any other procedures in the method may be performed in the order presented, in a different order or simultaneously. Further, in some embodiments, some of the actions, acts, blocks, operations, or any other procedures may be omitted, added, modified, skipped, or the like without departing from the scope of the embodiments of the present disclosure.

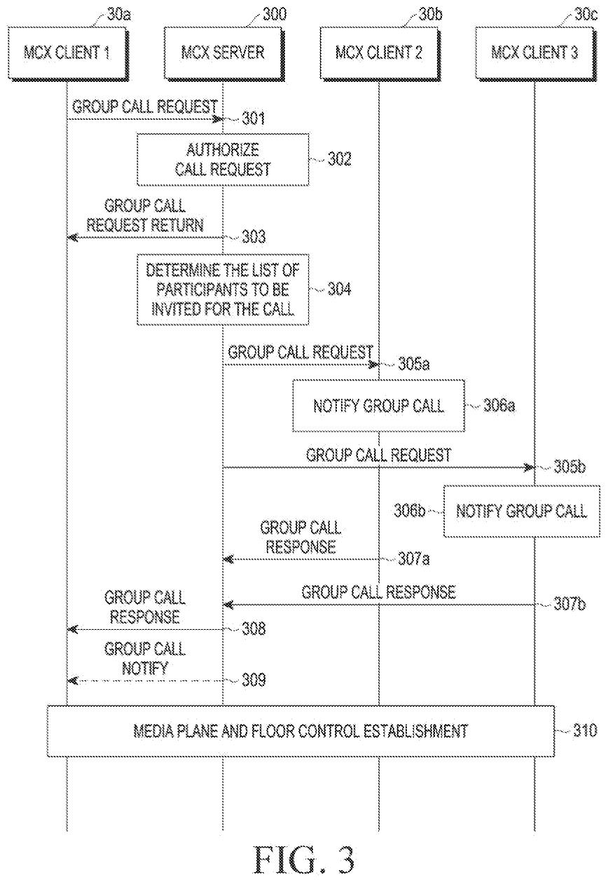

FIG. 3 is an example illustrating an operation-by-operation procedure for identifying a Group of First Responders (FRs), according to one or more embodiments.

Referring to FIG. 3, the MCX Client 1 30a initiates the group call request. The group call request may include a rule-set information without a participants list. Based on the rule-set information, the MCX Server 300 may identify the group of participants/MCX clients and initiate the group call request.

At operation 301, an MCX client 1 30a may identify the mission critical event and send the group call request to the MCX server 300. The group call request may be in the form of one or more data packets transmitted wirelessly between MCX Client 1 30a and MCX Server 300. The data packets may include a header with address information identifying a source (e.g., MCX Client 1 30a) and a target (MCX server 300). The data packets may further include a payload that includes the rule-set information for the group call request. The rule-set information may include, but is not limited to, the location range, the emergency type, the minimum number of MCX clients/first responders (FRs), the availability of the MCX clients/FRs, and the expert level of the MCX clients/FRs. The group call request may include the location of the MCX client 1 30a and also the rule-set information based on the location range keeping the location of the MCX client 1 30a as a center point.

At operation 302, the MCX server 300 determines if a group call feature is supported. For example, the MCX server 300 may examiner the incoming data packets to extract header information (e.g., information specifying the MCX Client 1 30a) as well as payload information (e.g., information specifying a rule-set). If the MCX server 300 supports the group call feature, the MCX server 300 accepts the group call request. The MCX server 300 checks whether the MCX client 1 30a is authorized to initiate a group call and proceed with the rest of the operations.

At operation 303, if the MCX server 300 fails to support the group call feature, the MCX server 300 rejects the group call request and es not continue with the rest of the operations.

At operation 304, the MCX server 300 determines the list of participants/MCX clients to be invited for the group call based on the rule-set information specified in operation 301 (e.g., the location range).

At operations 305a and 305b, the MCX server 300 sends the group call requests towards the list of participants/MCX clients determined in operation 304. The list of participants/MCX clients may include, but is not limited to, the MCX client 2 30b and the MCX client 330c.

At operations 306a and 306b, the MCX client 2 30b and the MCX client 3 30c are notified about the group call on receiving the group call requests from the MCX server 300. The MCX clients may receive one or more data packets transmitted wirelessly from the MCX server that includes a notification about the group call.

At operations 307a and 307b, the MCX client 2 30b and the MCX client 3 30c accept the group call requests and send group call responses to the MCX server 300. The responses may be included in one or more data packets transmitted wirelessly from the MCX clients to the MCX servers. The group call responses are verified (e.g., valid and activated for the MCX client) by the MCX server 300.

At operation 308, the MCX server 300 sends the group call response with the list of participants/MCX clients (30b, 30c) to the MCX client 1 30a through a signaling path to inform the MCX client 1 30a about successful call establishment.

At operation 309, the MCX client 1 30a is notified about the group call on receiving the group call response with the list of participants/MCX clients (30b, 30c) from the MCX server 300.

At operation 310, the MCX server 300 initiates the wireless communication such as for example the ad hoc communication between the MCX client 1 30a, the MCX client 2 30b and the MCX client 3 30c.

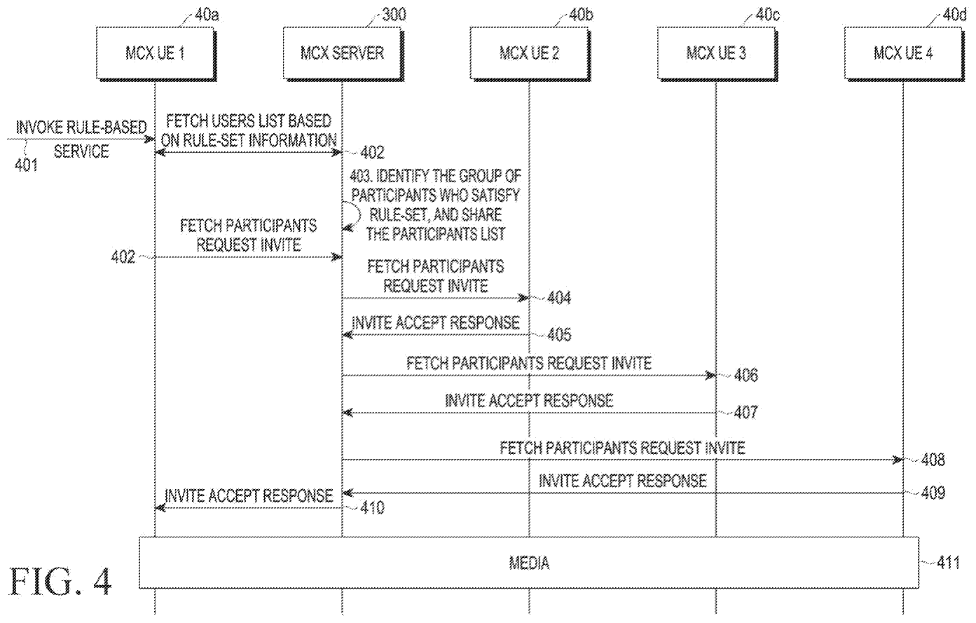

FIG. 4 is an example illustrating an operation-by-operation procedure for fetching a participants list using rule-set information, according to one or more embodiments. The communication between each MCX UE and the MCX server may be performed by wireless transmission of one or more data packets, where either the MCX UE or the MCX server extracts information from the one or more data packets.

Referring to FIG. 4, an MCX UE 1 40a of the MCX client 1 30a retrieves the list of MCX clients (30b, 30c) satisfying the certain condition (e.g. location range) from the MCX server 300 and initiates the group call.

At operation 401, a rule-based service is invoked upon identifying the mission critical event.

At operation 402, the MCX UE 1 40a of the MCX client 1 30a sends a fetch participants request to the MCX server 300 in order to get the list of participants/MCX clients residing in a specified location range. The fetch participants request includes the location information of the MCX client 1 30a and the rule-set information including the location range.

At operation 403, the MCX server 300 determines whether the MCX client 1 30a is authorized to make the fetch participants request. The MCX server 300 proceeds with rest of the operations if the MCX server 300 determines that the MCX client 1 30a is authorized to make the fetch participants request. The MCX server 300 determines the list of participants/MCX clients that satisfy the condition specified in the rule-set information of the fetch participants request as in operation 402.

At operations 404, 406 and 408, the MCX server 300 sends the fetch participants request to the determined list of participants/MCX clients satisfying the condition specified in the rule-set information of the fetch participant request. The determined list of participants/MCX clients may include, but is not limited to, the MCX client 2 30b, the MCX client 3 30c and the MCX client 4 30d holding the MCX UE 2 40b, the MCX UE 3 40c and the MCX UE 4 40d, respectively.

At operations 406, 407 and 409, the MCX server 300, after determining the list of participants/MCX clients (e.g., the MCX client 2 30b, the MCX client 3 30c and the MCX client 4 30d), receives the invite accept response from the MCX client 2 30b, the MCX client 3 30c and the MCX client 4 30d.

At operation 410, the MCX server 300 sends the invite accept response from the MCX client 2 30b, the MCX client 3 30c and the MCX client 4 30d to the MCX client 1 30a. The MCX server 300 proceeds with the establishment of the ad hoc group call tagged with an ad hoc Group Name inviting the MCX client 2 30b, the MCX client 3 30c, and the MCX client 4 30d determined in operation 403.

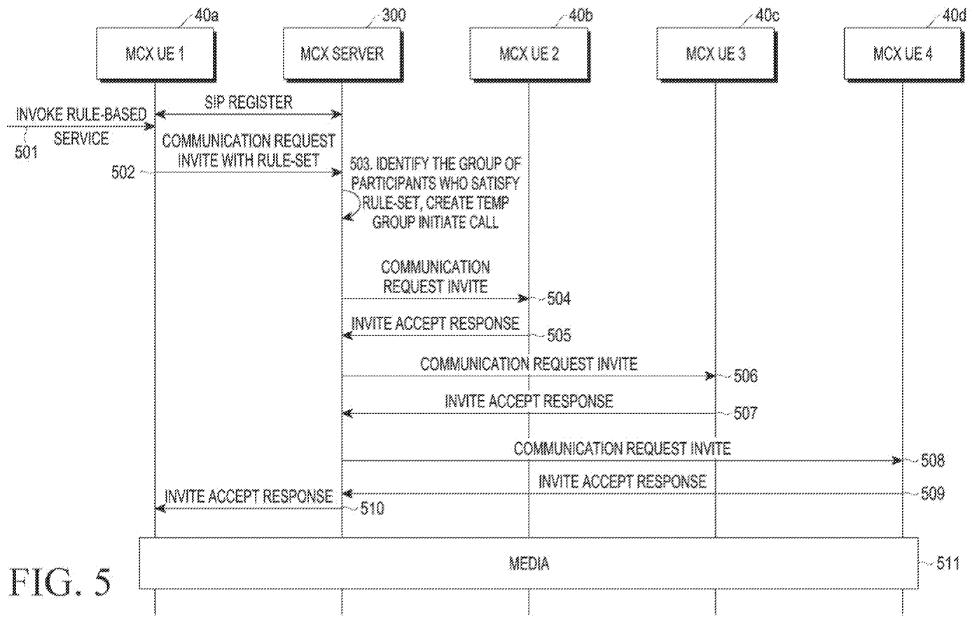

FIG. 5 is an example illustrating an operation-by-operation procedure for sending communication request invite with the rule-set information to other MCX clients/FRs, according to one or more embodiments.

Referring to FIG. 5, the MCX Client 1 30a using the MCX UE 1 40a initiates an invite request with the rule-set information. Based on the rule-set information, the MCX server 300 determines the group of participants/MCX clients. Upon determining the group of participants/MCX clients, the MCX Server 300 creates a temporary group and initiates the group call.

At operation 501, the rule-based service is invoked upon identifying the mission critical event.

At operation 502, the MCX client 1 30a initiates a private call with the MCX server 300 by including the location of the MCX client 1 30a and also the rule-set information based on the location range keeping the location of the MCX client 1 30a as the center point. The MCX client 1 30a initiates the private call with the MCX server 300 by sending a communication request invite (e.g. ad hoc group call invite with the rule-set information) to the MCX server 300.

At operation 503, the MCX server 300 determines the need for multiple participants group call and decides the list of participants/MCX clients to be invited for that group call based on the rule-set information specified in the operation 502 (e.g., the location range). The MCX server 300 uses the rule-set information provided by an initiator of the call (e.g., the MCX client 1 30a) to determine the list of participants/MCX clients along with its own criteria or local policies.

At operations 504, 506 and 508, the MCX server 300 creates the temporary group with the determined participants/MCX clients list and initiates the group call, by sending the communication request invite to the MCX client 2 30b, the MCX client 3 30c and the MCX client 4 30d holding the MCX UE 2 40b, the MCX UE 3 40c and the MCX UE 4 40d, respectively. The MCX client 2 30b, the MCX client 3 30c, and the MCX client 4 30d are notified about the communication request invite and an incoming group call.

At operations 505, 507 and 509, the MCX client 2 30b, the MCX client 3 30c and the MCX client 4 30d accept the communication request invite, and send the invite accept response or the group call responses to the MCX server 300.

At operation 510, the MCX server 300 sends the group call response with the list of participants/MCX clients determined by the MCX server 300 indicating that the group call response is now converted to an ad hoc group call with the temporary group name to the MCX client 1 30a through the signaling path to inform about successful call establishment.

At operation 511, the MCX server 300 initiates the ad hoc group call between the MCX client 1 30a and the determined participants/MCX clients (30b-30d) efficiently.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method for rule-based mission critical (MCX) communication by an MCX server, the method comprising:
receiving, from an MCX client, an MCX service request which comprises rule-set information for the MCX service request;
determining at least one MCX participant required for the MCX service request based on the rule-set information for the MCX service request; and
initiating wireless communication between the determined at least one MCX participant and the MCX client based on the rule-set information for the MCX service request.

2. The method of claim 1, wherein the rule-set information comprises at least one of a location information, an emergency type, a minimum number of MCX clients/first responders (FRs), an availability of the MCX clients/FRs, and an expert level of the MCX clients/FRs.

3. The method of claim 1, wherein the determining the at least one MCX participant required for the MCX service request comprises:
receiving, from the MCX client, a fetch participants request which comprises rule-set information for the fetch participants request;
verifying the fetch participants request received from the MCX client based on the rule-set information for the fetch participants request; and
determining the at least one MCX participant satisfying the rule-set information for the fetch participants request.

4. The method of claim 1, wherein the initiating the wireless communication between the determined at least one MCX participant and the MCX client comprises:
sending a communication request invite to the at least one determined MCX participant;
receiving an invite accept response from the at least one determined MCX participant;
verifying the received invite accept response based on the received rule-set information; and
sending the verified invite accept response to the MCX client to establish the wireless communication between the determined at least one MCX participant and the MCX client.

5. The method of claim 4, wherein the communication request invite is sent to the determined MCX participant based on identifying a mission critical event.

6. A method for rule-based mission critical (MCX) communication by an MCX server, the method comprising:
receiving, from an MCX client, an ad hoc group call request which comprises rule-set information for the ad hoc group call request;
identifying a mission critical event based on the ad hoc group call request received from the MCX client;
determining, upon identifying the mission critical event, a group of MCX participants required for the ad hoc group call request; and
initiating an ad hoc group call between the determined group of MCX participants and the MCX client based on the rule-set information for the ad hoc group call request.

7. The method of claim 6, wherein the rule-set information comprises at least one of a location information, an emergency type, a minimum number of MCX clients/first responders (FRs), an availability of the MCX clients/FRs, and an expert level of the MCX clients/FRs.

8. The method of claim 6, wherein the initiating the ad hoc group call between the determined group of MCX participants and the MCX client comprises:
sending an ad hoc group call invite to the determined group of MCX participants;
receiving the invite accept response from the determined group of MCX participants;
verifying the received invite accept response based on the received rule-set information; and
sending the verified invite accept response to the MCX client to establish the ad hoc group call between the determined group of MCX participants and the MCX client.

9. A mission critical (MCX) server for rule-based MCX communication, the MCX server comprising:
a memory;
a communicator; and
at least one processor coupled to the memory and the communicator, wherein the at least one processor is configured to:
receive, from an MCX client, an MCX service request which comprises rule-set information for the MCX service request;
determine at least one MCX participant required for the MCX service request based on the rule-set information for the MCX service request; and
initiate wireless communication between the determined at least one MCX participant and the MCX client based on the rule-set information for the MCX service request.

10. The MCX server of claim 9, wherein the at least one comprises at least one of a location information, an emergency type, a minimum number of MCX clients/first responders (FRs), an availability of the MCX clients/FRs, and an expert level of the MCX clients/FRs.

11. The MCX server of claim 9, wherein the at least one processor is configured to determine the at least one MCX participant required for the MCX service request by:
receiving, from the MCX client, a fetch participants request which comprises rule-set information for the fetch participants request;
verifying the fetch participants request received from the MCX client based on the rule-set information for the fetch participants request; and
determining the at least one MCX participant satisfying the rule-set information for the fetch participants request.

12. The MCX server of claim 9, wherein the at least one processor is configured to initiate the wireless communication between the determined MCX participant and the MCX client by:
sending a communication request invite to the determined at least one MCX participant;
receiving an invite accept response from the determined at least one MCX participant;
verifying the received invite accept response based on the received rule-set information; and
sending the verified invite accept response to the MCX client to establish the wireless communication between the determined at least one MCX participant and the MCX client.

13. The MCX server of claim 12, wherein the communication request invite is sent to the determined MCX participant based on identifying a mission critical event.

14. A mission critical (MCX) server for rule-based MCX communication, the MCX server comprising:
a memory;
a communicator; and
at least one processor coupled to the memory and the communicator, wherein the at least one processor is configured to:
receive, from an MCX client, an ad hoc group call request which comprises rule-set information for the ad hoc group call request;
identify the mission critical event based on the ad hoc group call request received from the MCX client;
determine a group of MCX participants required for the ad hoc group call request upon identifying the mission critical event; and
initiate an ad hoc group call between the determined group of MCX participants and the MCX client based on the rule-set information for the ad hoc group call request.

15. The MCX server of claim 14, wherein the rule-set information comprises at least one of a location information, an emergency type, a minimum number of MCX clients/first responders (FRs), an availability of the MCX clients/FRs, and an expert level of the MCX clients/FRs.

16. The MCX server of claim 14, wherein the at least one processor is configured to initiate the ad hoc group call between the determined group of MCX participants and the MCX client by:
sending an ad hoc group call invite to the determined group of MCX participants;
receiving the invite accept response from the determined group of MCX participants;
verifying the received invite accept response based on the received rule-set information; and
sending the verified invite accept response to the MCX client to establish the ad hoc group call between the determined group of MCX participants and the MCX client.
